(19) United States
(12) Patent Application Publication
(10) Pub. No.: US 2005/0024815 A1
(43) Pub. Date: Feb. 3, 2005

(54) Latch fuse

(76) Inventor: John D. Pratt, Laguna Niguel, CA (US)

Correspondence Address: BARNES & THORNBURG, P.O. BOX 2786, CHICAGO, IL, 60690-2786, US

(21) Appl. No.: 10/655,106

(22) Filed: Sep. 3, 2003

Related U.S. Application Data
(60) Provisional application No. 60/490,978, filed on Jul. 29, 2003.

(51) Int. Cl. H02B 1/00

(52) U.S. Cl. 361/600

(57) ABSTRACT

Disclosed is a latch assembly that includes an in-line fuse, which prevents damage to the latch assembly and its component parts in the event that a force in excess of a predetermined force is exerted on the latch handle. The latch assembly includes a latch housing and a latch, which is mounted in the latch housing. The latch includes a latch handle having a trigger assembly adapted to retain and release the handle from a locked position. The latch handle in turn causes an arm assembly to cause the movement of a push/pull type cable assembly. The in-line fuse is pivotally mounted to the arm assembly, and positioned in-line with the push/pull cable. The in-line fuse pin includes a sacrificial section that is designed to change in the event that excessive forces are applied to the latch handle. Thus, when a latch assembly operator exerts excessive force in an attempt to move the latch into the locked position, and corrosion or an obstruction are present to prevent the locking mechanism from locking the panel, the in-line fuse pin will fail, thereby preventing damage to the latch mechanism and cable assembly. Once the in-line fuse pin fails, the latch loses resistance, alerting the operator that a problem with the latch mechanism needs to be corrected.

This application claims the benefit of U.S. Provisional Application No. 60/490,978, filed Jul. 29, 2003.

### BACKGROUND

This disclosure relates to a latch assembly including an in-line fuse pin that is designed to be a sacrificial component which functions to prevent damage to the latch mechanism, in the event that an excessive force is exerted on a component of the latch assembly.

Various types of latches join and lock a first aircraft structure, such as an aircraft panel or cowling, to a second aircraft structure. A typical latch includes a hook latch mounted to one half of an aircraft cowling that engages a keeper mounted to the other half as well as a reversal of these components. Some latches include a handle directly connected to the hook such that the latch is directly operable by a latch operator, while other latches are not directly operable by a latch operator.

For example, cowling halves are sometimes secured to each other at the top of the cowling, near the hinge lines, by remote, top-mounted latches. Such top-mounted latches may be inaccessible and are not readily visible to operators on the ground. Several types of top-mounted latches attempt to solve the problem of inaccessibility by permitting remote operation. These top-mounted latches commonly include a hook latch to engage the keeper. The hook latch is connected to, and actuated by, a push/pull cable which, in turn, is connected to a handle mechanism located at the bottom of the cowling. This allows an operator to remotely open and close the top-mounted latch by the use of the handle. When the top-mounted latch is remotely opened, the hook disengages from the keeper allowing the cowling to be opened. After closing the cowling, the top-mounted latch may be remotely closed by an operator simply toggling the handle at the bottom of the cowling.

Sometimes parts of the latch can become corroded. Such corrosion may cause an increase in friction in the latch. Friction or debris in the latch actuation member restricts complete closure of the cowling. Such circumstances may cause a mechanic to exert higher-than-desired loads to close the latch handle. The excessive loads placed upon the cable latch in-turn, in an effort to overcome resistance caused by the corrosion or debris, can cause excessive forces on and damage to the cable assembly. Damage to the cable assembly and/or associated latch can be costly and difficult to replace. Certain latches are designed such that a mechanic has the ability to exert excessive cable latch handle opening forces by continuing to pull on the handle after it has been fully extended in the open position. While in some cases this may release the latch mechanism, in others, expensive and time consuming repairs are required to fix the over loaded cables or latches.

In view of the above, it should be appreciated that there is a need for a latch assembly including a fuse assembly that limits excessive forces from being exerted on the latch assembly, to prevent damage from occurring to underlying components. The present disclosure satisfies these and other needs and provides further related advantages.

### SUMMARY

The disclosure includes an in-line fuse device and fuse assembly for use with a latch assembly to prevent failure to the latch assembly and its component parts in the event that excessive force is exerted on the latch handle.

The latch assembly includes a latch housing and a latch, which is mounted in the latch housing. The latch includes a latch handle having a trigger assembly adapted to release the handle from a locked position. The latch handle in turn causes an arm assembly to slide along a pair of side plates, directly causing the movement of a push/pull type cable assembly. The latch also includes a linkage that is moveable in and out of a locked position.

The in-line fuse assembly can be pivotally mounted to the arm assembly, and generally positioned in-line with the push/pull cable. The in-line fuse pin includes a section that is designed to be a sacrificial component which functions to break or otherwise predictably and/or controllably fail in the event that excessive forces are applied to the latch handle. The in-line fuse is configured such as by, but not limited to a reduced cross-section, a tapered cross-section, or use of different materials. The fuse provides a controlled, intentionally positioned weak link in the latch assembly which can be controllably engineered to fail under predetermined conditions.

Thus, when a latch operator exerts excessive force in an attempt to move the latch handle into a locked position, and corrosion or an obstruction interfere with the operation of the locking mechanism, the in-line fuse pin will, controllably operate to limit or prevent damage to the latch mechanism and cable assembly. For example, when the in-line fuse pin fails, the latch handle loses resistance, alerting the operator that a problem with the latch mechanism exists and needs to be corrected.

Users desire an overload preventing fuse that will function before more costly damage occurs to difficult-to-replace latch assembly components in the load path. Such a fuse can be sacrificed to prevent damage to the latch assembly. An overload situation may arise if corrosion increases friction in the latch actuation members, causing a mechanic to exert higher-than-desired loads to close the cable latch, which in-turn could exert excessive forces on the cable assembly (the cable assembly is costly and difficult to replace). Certain latch designs are such that a mechanic may also exert excessive cable latch handle opening forces by continuing to pull on the handle after it has been fully opened. It is also possible for debris to jam the mechanism, so that a mechanic may try to overcome the obstruction by exerting excessive forces to open or close the cable latch handle.

Other features and advantages of the disclosure will be set forth in part in the description which follows and the accompanying drawings, wherein the embodiments of the disclosure are described and shown, and in part will become apparent upon examination of the following detailed description taken in conjunction with the accompanying drawings.

### BRIEF DESCRIPTION OF THE DRAWINGS

FIG. 1 is a perspective view of a latch assembly in an open configuration;

FIG. 2 is a perspective view of an arm member of the latch assembly;

FIG. 3 is a side elevational view of the latch assembly in FIG. 1;

FIG. 4 is a partial fragmentary, perspective view of an in-line fuse pin on the latch assembly, partially disassembled;

FIG. 5 is a sectional view of the in-line fuse pin assembly taken along line 5-5 in FIG. 4, fully assembled;

FIG. 6 is a sectional view of the in-line fuse pin;

FIG. 7 is a perspective view illustrating the top side of the latch assembly; and

FIG. 8 is a perspective view illustrating the bottom side of the latch assembly.

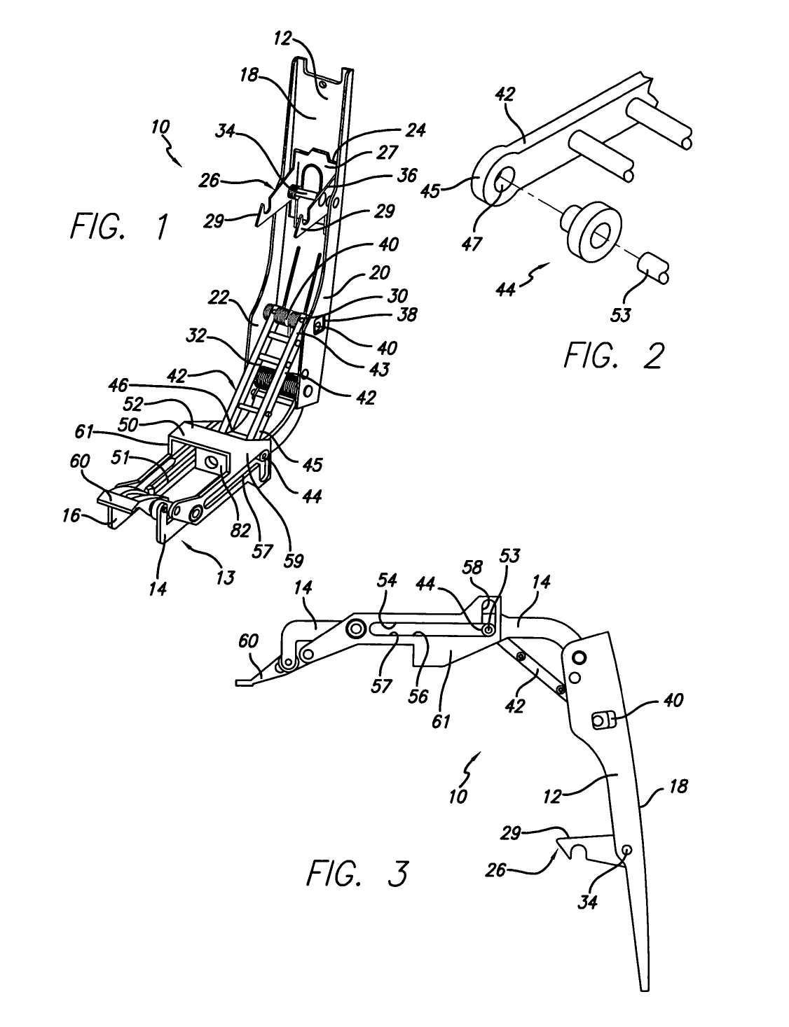

### DETAILED DESCRIPTION

As illustrated in the drawings a latch assembly 10 includes an in-line fuse assembly 48 to prevent damage to the latch assembly 10 and related structures. As shown in the exemplary drawings, and with particular reference to FIG. 1, a latch assembly 10 having a latch handle 12 is movably connected, shown here as pivotally-connected, to a latch housing 13 defined by a first and a second side plate 14, 16. The handle 12 is shown as a channel-shaped member that is adapted to allow a latch operator to open and close the latch assembly 10. When in the closed position, the latch handle 12 generally covers or overlies the first and second side plates 14, 16.

The latch assembly 10 is adapted to be mounted to an aircraft structure such as a cowling 17 of an engine nacelle. The latch assembly 10 provides remote latching and/or releasing of a latch system 11 as shown in FIG. 9. The latch assembly system 11 includes the latch assembly 10 and a corresponding second latch system 21 including a hook latch 23 and keeper 25. While the hook latch and keeper 23, 25 are shown, other second latching systems 21 are envisioned for use with the latch assembly system 11 as shown and described. The latch assembly system 11 also includes means for remotely operating the second latch system 21 connected to the latch assembly 10. In this regard, one form of the remote operating means 29 is a cable assembly 94 as described in greater detail herein below. The latch assembly system 11 as shown in FIG. 9 is shown in a general diagrammatic illustration and is not intended to be representative of the respective dimensions or sizes of the components. The illustration of FIG. 9 is provided for illustrative purposes only and is not in any way intended in any way to limit the present application to the specific embodiments as shown or described therein.

As shown in FIGS. 1 and 3, the latch handle 12, includes a top wall 18, that forms the top most surface of the latch assembly 10 and a pair of sidewalls 20 and 22 that are aligned parallel to each other, and perpendicular to the top wall 18. The top wall 18 includes an opening 24 that is adapted to accept a trigger assembly 26. The trigger assembly 26 includes a control 27 having a pair of engaging arms 29 which are adapted to engage a pair of bushings 44, to retain the latch handle 12 in a closed position. When the trigger control 27 is depressed by the latch operator, the handle 12 is biased to an open position by a series of springs 30, 32. The trigger assembly 26 includes a pivot pin assembly 34 that allows the trigger assembly 26 to pivot from a closed position to an open position. The trigger assembly 26 is biased to a locked position by the use of a spring 36, such as a dual helix torsion spring as shown that is mounted on the pivot pin assembly 34.

While the description refers to a latch assembly 10 for use with an aircraft panel, it is within the scope of the present application and fully envisioned herein that the disclosure is applicable to ships, land vehicles, trains or any other vehicle or latching assembly which may be used on buildings or other non-vehicular structures. The description set forth herein should be expansively applied to any situation in which such a latch assembly and latch mechanism might be used in any number of situations. As will be described in greater detail herein, a fuse assembly 48 in combination with the latch mechanism 10 and latch assembly 11 generally prevents damage to the latch mechanism and latch assembly, and any related structures or components, as a result of a fuse 62 failing in any one of many structural modes in the event of a force greater than a predetermined limit is applied to the fuse 62.

The first and second sidewalls 20 and 22 include apertures 38 that are adapted to allow the placement of a pin 40 that retains arms 42. The arms 42 include a first end 43 and a second end 45. The arms 42 are pivotally connected to the latch handle 12 at a first end and are pivotally connected to a pair of bushings 44 at the second end that extend outwardly from housing 46 of fuse assembly 48. The second end 45 of the arms 42 include bores 47 that are adapted to receive busings 44 which engage cross members of posts 53. The bushings 44 slidably engage a pair of channels 51 in the first and second side plates 14, 16. Housing 74 has posts 53 onto which rollers 44 fit (See FIG. 5)

The latch assembly 10 further includes a trigger closure assembly 50 that retains the latch handle 12 in an open position prevent accidental closure. The trigger closure assembly 50 includes a crossbar 52 and first and second side members 59, 61 that are parallel with respect to each other and perpendicularly oriented to the crossbar 52. The side members 59, 61 of the trigger closure assembly 50 each include an L-shaped channel 57 that extends along the length of the side members 59, 61. The channels 57 include a horizontal leg 56 and a vertical leg 58. The channels 57 are adapted to slidably accept the bushings 44. When the latch handle 12 is pivoted to an open position, the bushings 44 are slid or rolled along the horizontal surface of the leg 56 of the channels 57 until arrival at the vertical leg 58. Upon encountering the vertical leg 58 of the channels 57 the trigger closure assembly 50 is biased downward by a spring (not shown) located under a trigger lock 60 to lock the latch handle 12 in an open position. This arrangement prevents unintended closure of the latch handle 12. Depressing the trigger closure assembly 50 aligns the bushings 44 with the horizontal leg 56 of the channels 54 to allow the latch handle 12 to be moved to the closed position.

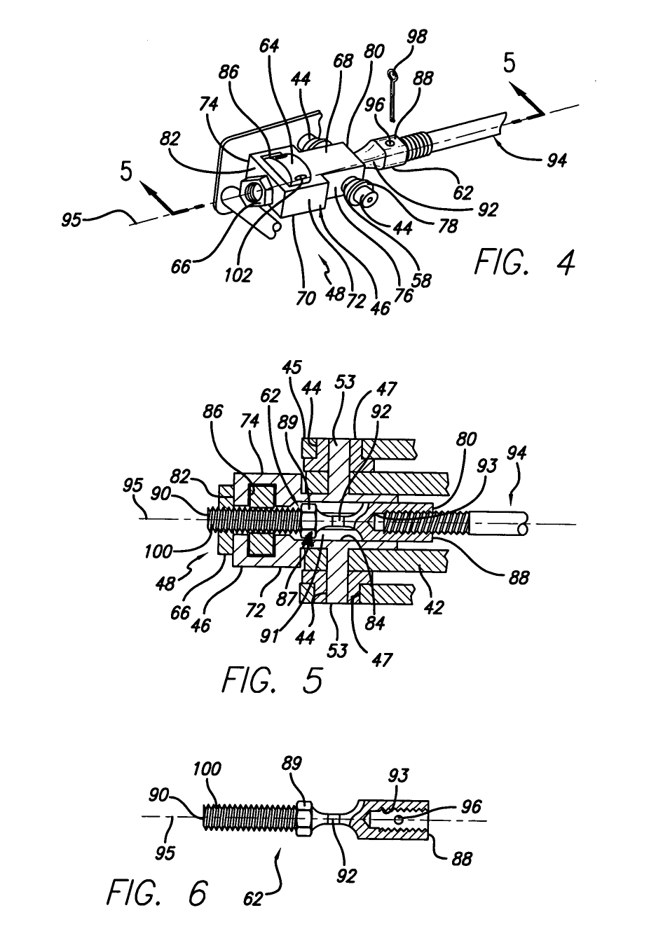

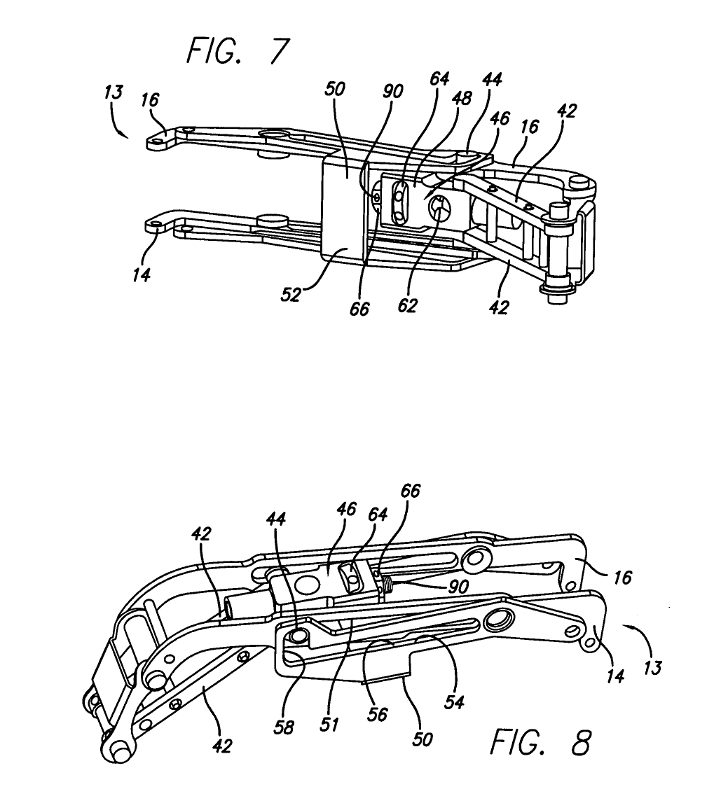

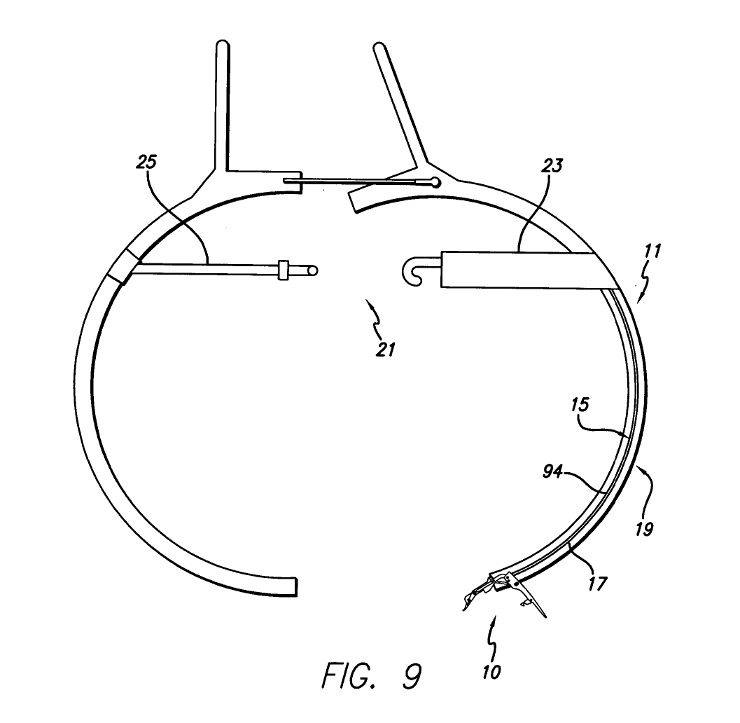

The fuse assembly 48, as shown in FIGS. 4-6, is pivotally connected to the second end 45 of the arms 42. The fuse assembly 48 includes the housing 46, a fuse 62, a retaining nut 64 and a lock nut 66. The housing 46 of the fuse assembly 48 includes a top surface 68, a spaced apart bottom surface 70, a first side surface 72 and a spaced apart second side surface 74. The side surfaces include a recessed portion 76 that includes outwardly extending posts 78 adapted to accept arms 42. The housing 46 of the fuse assembly 48 further includes a first end surface 80 spaced apart from a second end surface 82. The housing 46 of the fuse assembly 48 includes a bore 84 that extends from the first end surface 80 through to the second end surface 82. The bore 84 is dimensioned to allow for the axial passage of the fuse pin 62. The housing 46 of the fuse assembly 48 further includes a slot 86 communicating with the bore 84. A retaining nut is positioned in the slot 86 for engaging the fuse pin 62 extending through bore 84.

A means 87 for preventing torsional stresses on the fuse 62 is provided. One form of the means for preventing torsional stresses is embodied as a flatted region positioned along the fuse 62. A corresponding surface 91 is provided in the bore 84 for resisting rotation of the fuse 62 when adjusting the fuse 62. The torsion resisting means 87 generally eliminates rotary or torsional stresses on the fuse 62 and generally applies stresses along a central axis 95. It should be noted that the torsion resisting means 87 is shown as a “flatted” region but other variations and forms may be used such as a knurled section and corresponding internal knurled section, a multi-lobular region 89 and corresponding section 91 as well as other shapes and configurations which generally resist torsional forces and permit axial movement along a central axis 95. Using some form of torsion resisting means helps to prevent torsional stresses from effecting the fuse breaking load such that torsional stresses are not imparted or are prevented from being imparted to the sacrificial area or neck area 92.

During adjustment of the tension on the fuse 62 the adjuster while retaining nut 64 is rotated to draw or release a threaded rod section 100 through the bore 84. Once a desired tension is set in the fuse 62, a lock nut 66 is positioned to maintain the desired adjustment. During the adjustment process, the means for resisting torsional stresses 87 generally prevents rotation or torsional movement of the fuse and facilitates application of the adjusting forces by the adjuster 64 along the central axis 95.

The fuse 62 is illustrated in the drawings as a generally elongated, rod shaped member having a first end 88 and a spaced apart second end 90 referred to herein as a fuse pin 62. The fuse pin 62 is a sacrificial component which is configured to fail, break, or otherwise result in a change in its characteristics when excessive force is applied to the latch. Fuse 62 is one form or embodiment of a means for failing the connection between the latch assembly 10 and the cable assembly 94. The operation of the fuse 62 renders the latch assembly 10 inoperable before damage may occur to other components in the latch assembly 10. The fuse 62 provides a controlled, intentionally positioned weak link in the latch assembly which can be controllably engineered to fail only under predetermined conditions. The fuse 62 is easily accessible to allow for replacement upon failure. The fuse 62 is adapted to be positioned within and extending through the bore 84 of the housing 46 and is designed to fail at a sacrificial piece illustrated herein generally as a mid-section 92 of the fuse 62, if an excessive load is placed thereupon. With reference to the sacrificial piece means that the sacrificial piece 92 is part of the whole fuse. While the sacrificial piece 92 is part of the whole fuse 62 it may be composed of a different material, a different physical portion, a portion of a continuous piece of material which has been treated in manner to produce different mechanical results or any number of embodiments which will result in the operation of the fuse 62 described herein. The reference to fuse 62 as used herein to identify a device that in some way fails or changes characteristics in the event that a force greater than a predetermined limit is applied to the latch assembly. Operation of the latch assembly, generally in the opening or closing mode whether operated manually by a latch operator or unintentionally under other circumstances. In this regard, the fuse 62 may take many different physical embodiments including a pin 62 as illustrated herein, a plate, a panel a linkage as well as any other physical embodiment which might provide the same function as the fuse 62 as described herein or any other means for failing, one embodiment being the fuse 62 shown and described herein.

The first end 88 of the fuse pin 62 includes a first attachment structure shown in the form of a threaded bore 93 that is adapted to engage a threaded end 97 of a cable assembly 94. The first end 88 may include an aperture 96 that is adapted to accept a cotter pin 98 or lock wire to help prevent the cable assembly 94 from disengaging from the fuse pin 62. While the cotter pin 98 engaged in the aperture 96 may not be essential to the disengagement it may provide additional assistance in some situations. Generally, the torsion resisting means 87 associated with the fuse 62 prevents rotation of the fuse 62 while traveling in or positioned in the bore 84 thereby preventing rotation of the first end 88 relative to the threaded end 97 of the cable assembly 94.

The second end 90 of the fuse pin 62 includes a second attachment structure shown in the form of a threaded rod section 100 that is adapted to accept the retaining nut 64 and the lock nut 64. The retaining nut 64 includes apertures 102 which can be engaged by a tool to adjust the tension on the fuse 48. The lock nut 66 is positioned against second end surface 82 of the housing 46 and retains the position of the fuse pin 62 to maintain the correct adjustment of the cable assembly 94.

If more tension is required on the cable assembly 94 the retaining nut 64 is tightened to pull a greater portion of the fuse pin 62 into the housing 46, the lock nut 66 retains the adjustment. The sacrificial piece 92 of the fuse 62 is configured to change in the event an excessive force is applied to the latch. As shown in FIGS. 4-6, the sacrificial piece 92 is in the form of a narrowed or necked section of a structure and dimension to separate in the event that a load is applied exceeding the capacity of the material. The fuse 62 operates when the load is applied exceeding the capacity of the material to further neck result of additional tension being applied thereto. As a result of the occurrence of the additional necking or stretching of the material, the latch cannot be further operated. Additionally, if the operator tries to close the latch elongation of the pin material will prevent closing of the latch. As a result, the fuse is operable in two modes to prevent damage to the latch assembly system.

The fuse 62 can be designed to allow for various latch handle 12 loads without causing damage to the fuse 62. The diameter of the sacrificial piece 92 of the fuse pin 62 can be increased for a higher resistance to failure and decreased for a lower resistance to failure. Alterations in the material the fuse pin 62 is fabricated from will also vary its rate of failure. Variations in the steel used will alter the load in which the fuse pin 62 will fail. Some of the materials utilized to fabricate the fuse pin 62 include annealed AISI 300-series, 15-5H900, and 13-8H950 stainless steels. For example, the diameter of the sacrificial piece 92 is sized to enable 25,000 cycles of fully-reversed load of 895.6 lb at 250° C. In this situation a 17-4 PH H900 fuse tensile stress may be limited to 152,382 psi maximum allowable stress. This may translate to a diameter of 0.0985″/0.0995″ where 1.07 is assumed Kₜ and where 229,000 psi is the maximum expected breaking strength of 15-5 PH H900.

Cyclic life of 25,000 cycles at 250° C. is calculated as Load×Kₜ/(pi/4×d2)=max allowable stress where Kₜ=1.07. The load for the hypothetical case is 895.6 lb divided by the temperature reduction factor of 0.86 for 17-4PH-H900 stainless steel at 250° C. (=1,0411 lb which is the equivalent room temperature load) and maximum allowable stress=152,382 psi. Solving, the minimum diameter is d=0.0985″ minimum. Static strength maximum diameter is calculated as d maximum=d min.+0.0010=0.0995″. Maximum expected breaking strength is calculated as 229,000 psi×pi/4×d²=1,781 lb at room temperature.

The foregoing example and other examples set forth in this description are not intended in any way to limit the scope of the present applications and appended claims. Rather, these are provided as examples to further help understand and enable the described device, method and system. These examples are intended to be expansive to be broadly interpreted without limitation.

The sacrificial piece 92 of the fuse 62 as illustrated is a narrowed portion that is dimensioned to separate or deform in the event that a load is applied, exceeding a predetermined limit, such as the calculated failure stress of the material. The sacrificial piece 92 can be achieved through other mechanisms in addition to the reduced diameter section as shown. For example, while the dimension can be maintained another type of material, or a different material process can be used to produce the desired change in the fuse 62. The failure mechanism in the fuse 62 may be in the form of complete separation failure as well as, but not limited to continued narrowing or necking of the fuse 62 material or buckling. The fuse 62 may be controllably frangible at a predetermined limit in the sacrificial piece or may be designed to promote plastic deformation.

In use, the latch assembly 10 is attached to an aircraft structure and coupled to a cowling and is designed to retain the cowling or other panels on the aircraft in a closed position. When service of the aircraft or other access to the latched area is required for example when the cowling must be opened, the latch operator presses the control 27 of the trigger assembly 26 visible from the wall 18 of the latch handle 12. Operating the trigger assembly 26 allows the springs 30 and 32 to bias the latch handle 12 to an open position. The outward movement of the latch handle 12 exerts a force on the arms 42 causing the bushings 44 to slide along the horizontal leg 56 of the channels 57. The movement of the arms 42 causes the fuse assembly 48 to slide along the first and second side plates 14 and 16.

The movement of the fuse assembly 48 causes the fuse pin 62 to push the cable assembly 94, which releases the latch. If corrosion is present in the cable assembly 94 or in the latch mechanism or debris is present preventing the unlatching the panel, the fuse assembly 48 will buckle to prevent the latch operator from exerting excessive forces on the system by failing if the force applied exceeds a predetermined limit. The failure of the fuse pin 62 alerts the latch operator that a problem has occurred in the system due to corrosion, debris or other malfunction that is required to be corrected. Once the problem is corrected, the fuse pin 62 may be replaced without the need for complete removal of riveted panels or other components that may take hours to repair, delaying flight.

The fuse pin 62 is removed from the fuse assembly 48 by first removing the lock wire securing nut 66 and nut 64. Next, nut 66 is removed from the threaded rod section 100 of the second end 90. Once the lock nut 66 is removed, the retaining nut 64 can be rotated to remove the second end 90 of the fuse pin 62 from the housing 46. Since the fuse pin 62 may be separated at the mid-section, due to its failed state, the first end 88 of the fuse pin 62 can be removed from the housing 46. Once the fuse pin 62 is free from the housing 46, the cotter pin or lock wire 98 is removed from the aperture 96 (if the cotter pin is used) and the first end 88 of the fuse pin 62 is rotated to disconnect the threaded bore 93 from the cable assembly 94.

The replacement fuse pin 62 is first threaded onto the cable assembly 94. The cotter pin 98, if used, is positioned within the aperture 96. The fuse pin 62 is then inserted into the central bore 84 of the housing 46 until the fuse pin 62 comes into contact with and threadably engages the retaining nut 64. The retaining nut 64 is rotated until the fuse pin 62 is properly positioned within the housing 46, to ensure proper tension on the cable assembly 94. Once the proper orientation of the retaining nut 64 with respect to the fuse pin 62 is achieved, the lock nut 66 is installed to prevent the position of the fuse pin 62 from changing with respect to the housing 46. Once in position, a retaining wire(s) can be attached to the retaining nut 64 and lock nut 66 to prevent change in position.

Various features of the invention have been particularly shown and described in connection with the disclosure as shown and described, however, it must be understood that these particular arrangements merely illustrate, and that the disclosure is to be given its fullest interpretation within the terms of the appended claims.

1. A latch assembly for use with a latch assembly system for securing a structure, the latch assembly comprising:
a latch housing;
a latch handle moveably connected to the latch housing, the latch handle adapted to be moved between a closed position and an open position; and
a fuse associated with the latch handle, the fuse adapted to fail in the event that a force greater than a predetermined limit is applied to the latch handle.

2. The latch assembly of claim 1, wherein the fuse includes a first end, a spaced apart second end and a sacrificial piece.

3. The latch assembly of claim 2, wherein the fuse is adapted to be connected to the fuse housing at the first end and adapted to be secured to a cable at the second end.

4. The latch assembly of claim 1, further comprising means for resisting torsional stresses associated with the fuse.

5. The latch assembly of claim 1, further comprising a fuse housing associated with the latch housing, the fuse being at least partially positioned in the fuse housing.

6. The latch assembly of claim 5, further comprising means for resisting torsional stresses associated with the fuse.

7. The latch assembly of claim 6, the torsional stress resisting means including a shaped regions on the fuse and a corresponding shaped section of the fuse housing, the shaped region and the shaped section cooperatively engaged for resisting application of torsional stresses on the fuse.

8. The latch assembly of claim 4, further comprising an arm assembly pivotally connected to the latch handle at a first end and pivotally connected to the fuse housing at a second end.

9. The latch assembly moving structure of claim 4, wherein the fuse housing includes a bore adapted to allow the fuse to pass therethrough.

10. The latch assembly of claim 9, wherein the fuse housing includes a slot communicating with the bore, wherein a retaining nut is positioned in the slot for engaging the pin extending through the bore.

11. The latch assembly of claim 8, wherein the fuse housing includes posts that extend outwardly from the fuse housing and are adapted to be pivotally connected to the second end of the arm assembly.

12. The latch assembly of claim 2, wherein the sacrificial piece of the fuse being dimensioned to fail in the event that a force greater than a predetermined limit is applied to the latch handle.

13. A fuse assembly for use with a latch assembly having a moving structure, the fuse assembly comprising:
a fuse housing having a support member operatively connected to the latch assembly, the fuse housing defining a bore;
a fuse secured in the bore of the fuse housing, the fuse having a first end, a spaced apart second end and a sacrificial piece;
the first end of the fuse adapted to be connected to the moving structure of the latch assembly;
the second end adapted to engage a retainer associated with the fuse housing to maintain the position of the fuse within the fuse housing; and
the fuse adapted to fail in the event that a force greater than a predetermined limit is applied to the latch assembly.

14. The fuse assembly of claim 13, further comprising means for resisting torsional stresses associated with the fuse.

15. The latch assembly of claim 14, the torsional stress resisting means including a shaped regions on the fuse and a corresponding shaped section of the fuse housing, the shaped region and the shaped section cooperatively engaged for resisting application of torsional stresses on the fuse.

16. The fuse assembly of claim 13, the sacrificial piece of the fuse being sized such that a physical change in dimension occurs in the event that an excessive force is applied to the latch assembly.

17. The fuse assembly of claim 13, the sacrificial piece of the fuse being dimensioned such that buckling occurs in the event that an excessive force is applied to the latch assembly.

18. The fuse assembly of claim 13, the sacrificial piece of the fuse being dimensioned such that separation occurs in the event that an excessive force is applied to the latch assembly.

19. The fuse assembly of claim 13, the housing further comprising a slot communicating with the bore, wherein the retainer is positioned in the slot for engaging the fuse extending through the bore to maintain the position of the fuse.

20. The fuse assembly of claim 13 further including posts that extend from the housing and are adapted to be pivotally connected to the latch assembly.

21. The fuse assembly of claim 13, further comprising the first end of the fuse including a threaded bore adapted to threadably engage a cable.

22. The fuse assembly of claim 21, further comprising the first end of the fuse including an aperture communicating with the bore and adapted to receive a lock wire therethrough.

23. The fuse assembly of claim 10, further comprising the second end of the fuse including a plurality of threads adapted to engage the retainer.

24. A method for preventing damage to a latch mechanism, said method comprising the steps of:
providing a fuse, the fuse including a sacrificial piece;
dimensioning the sacrificial piece of the fuse so that the sacrificial piece will fail in the event that a force greater than a predetermined limit is applied to the latch mechanism;
securing the fuse to the latch mechanism; and
causing a failure of the fuse generally in the sacrificial piece upon application of a force to the latch mechanism greater than a predetermined limit.

25. The method according to claim 24, including the additional step of providing a fuse housing having a bore extending therethrough.

26. The method according to claim 25, including the additional step of positioning the fuse within the bore of the fuse housing.

27. The method according to claim 26, including the additional step of securing the fuse within the bore of the fuse pin housing by use of a retainer.

28. A latch assembly for securing a structure, the latch assembly comprising:
a latch housing;
a latch handle moveably connected to the latch housing, the latch handle adapted to be moved between a closed position and an open position;
a fuse associated with the latch handle the fuse adapted to fail in the event that a force greater than a predetermined limit is applied to the latch handle.

29. The latch assembly of claim 28, wherein the fuse is secured within a fuse housing.

30. The latch assembly of claim 28, wherein the fuse includes a first end, a spaced apart second end and a sacrificial piece.

31. The latch assembly of claim 30, wherein the fuse is adapted to be connected to the fuse housing at the first end and adapted to be secured to a cable at the second end.

32. The latch assembly of claim 28, further comprising means for resisting torsional stresses associated with the fuse.

33. The latch assembly of claim 28, further comprising a fuse housing associated with the latch housing, the fuse being at least partially positioned in the fuse housing.

34. The latch assembly of claim 33, further comprising means for resisting torsional stresses associated with the fuse.

35. The latch assembly of claim 34, the torsional stress resisting means including a shaped regions on the fuse and a corresponding shaped section of the fuse housing, the shaped region and the shaped section cooperatively engaged for resisting application of torsional stresses on the fuse.

36. The latch assembly of claim 29, further comprising an arm assembly pivotally connected to the latch handle at a first end and pivotally connected to the fuse housing at a second end.

37. The latch assembly of claim 29, wherein the fuse housing includes a bore adapted to allow the fuse to pass therethrough.

38. The latch assembly of claim 29, wherein the fuse housing includes a slot communicating with the bore, wherein a retaining nut is positioned in the slot for engaging the pin extending through the bore.

39. The latch assembly of claim 36, wherein the fuse housing includes posts that extend outwardly from the fuse housing and are adapted to be pivotally connected to the second end of the arm assembly.

40. The latch assembly of claim 30, wherein the sacrificial piece of the fuse being dimensioned to fail in the event that a force greater than a predetermined limit is applied to the latch handle.

41. A latch assembly system for securing a structure, the latch assembly system comprising:
a first latch including a housing and a latch handle moveably connected to the latch housing, the latch handle adapted to be moved between a closed position and an open position;
a second latch system positioned spaced from the first latch;
means for remotely operating the second latch system adapted to be connected to the first latch and the second latch system, operation of the first latch remotely operating the second latch system; and
means for failing the connection between the first latch and the second latch system in the event that a force greater than a predetermined limit is applied to the latch handle.

42. The latch assembly system of claim 41, wherein the means for failing is in the form of a fuse retained in the latch assembly system.

43. The latch assembly system of claim 42, wherein the fuse is secured within a fuse housing carried on the latch housing of the first latch.

44. The latch assembly system of claim 42, wherein the fuse includes a first end, a spaced apart second end and a sacrificial piece.

45. The latch assembly system of claim 44, wherein the fuse is adapted to be operatively associated with the fuse housing at a first end and adapted to be operatively attached to the remote operating means at a second end.

46. The latch assembly system of claim 43, wherein the fuse housing includes a bore adapted to receive at least a portion of the fuse.

47. The latch assembly system of claim 46, further comprising means for resisting torsional stresses associated with the fuse.

48. The latch assembly system of claim 46, further comprising a fuse housing associated with the latch housing, the fuse being at least partially positioned in the fuse housing.

49. The latch assembly system of claim 48, further comprising means for resisting torsional stresses associated with the fuse.

50. The latch assembly system of claim 49, the torsional stress resisting means including a shaped regions on the fuse and a corresponding shaped section of the fuse housing, the shaped region and the shaped section cooperatively engaged for resisting application of torsional stresses on the fuse.

51. A fuse for use with a latch assembly, the fuse comprising:
a first end;
a second end generally spaced form the first end;
a sacrificial piece; and
the first end of the fuse adapted to be connected to a latch assembly;
the second end adapted to engage a retainer associated a latch assembly; and
the fuse adapted to fail in the event that a force greater than a predetermined limit is applied to the latch assembly.

52. The fuse of claim 51, further comprising means for resisting torsional stresses associated with the fuse.

53. The fuse of claim 52, the torsional stress resisting means including a shaped regions on the fuse for engagement with a corresponding shaped section on a latch assembly, the shaped region and a shaped section cooperatively engaged for resisting application of torsional stresses on the fuse.

54. The fuse of claim 51, the sacrificial piece of the fuse being sized such that a physical change in dimension occurs in the event that an excessive force is applied thereto.

55. The fuse of claim 51, the sacrificial piece of the fuse being dimensioned such that buckling occurs in the event that an excessive force is applied thereto.

56. The fuse of claim 51, the sacrificial piece of the fuse being dimensioned such that separation occurs in the event that an excessive force is applied thereto.
